(19) United States
(12) Patent Application Publication
(10) Pub. No.: US 2012/0086752 A1
(43) Pub. Date: Apr. 12, 2012

(54) RECORDING APPARATUS

(75) Inventor: Takuya YASUE, Matsumoto-shi (JP)

(73) Assignee: SEIKO EPSON CORPORATION, Tokyo (JP)

(21) Appl. No.: 13/241,974

(22) Filed: Sep. 23, 2011

(30) Foreign Application Priority Data
Oct. 7, 2010 (JP) 2010-227392
Oct. 7, 2010 (JP) 2010-227395

(51) Int. Cl. B41J 2/165

(52) U.S. Cl. 347/23; 347/33

(57) ABSTRACT

A recording apparatus includes: a feeding unit which feeds a recording medium in a feeding direction; a recording head which discharges ink onto the recording medium for recording; and a first cleaning unit which performs first cleaning on at least one of a side surface on an upstream side of the feeding direction in the recording head, a side surface on a downstream side thereof, and side surfaces on both sides of a width direction of the recording medium with respect to the feeding direction.

### INCORPORATION BY REFERENCE

The entire disclosures of Japanese Patent Application No. JP2010-227392 filed on Oct. 7, 2010 and JP2010-227395 filed on Oct. 7, 2010 are expressly incorporated by reference herein.

### BACKGROUND

1. Technical Field

The present invention relates to a recording apparatus having a recording head which discharges ink onto a recording medium for recording.

In the present invention, the recording apparatus includes kinds such as an ink jet printer, a line printer, a copying machine, or a fax machine.

2. Related Art

According to the related art, as disclosed in JP-A-2006-306037, a printer includes a recording head which discharges ink. In addition, a surface of the recording head which opposes a sheet (nozzle formation surface) is provided with nozzles through which ink is discharged. In addition, a wiper capable of wiping away contaminants on the nozzle formation surface is provided. The wiper regularly cleans the nozzle formation surface. Therefore, the nozzle status can be stabilized to some extent.

However, since ink droplets discharged from the nozzles are small, parts of the ink droplets become ink mist and float. In addition, the ink droplets are adhered to the side surfaces of the recording head and become contaminants.

Here, problems of the related art are shown in FIGS. 5A and 5B.

FIGS. 5A and 5B show side views of a recording head according to the related art.

As shown in FIG. 5A, a carriage 60 includes a recording head 62 and is configured to move while being guided by guide shafts 61 in the width direction of a sheet 67. At a position opposing the recording head 62, a medium support portion 64 which supports the sheet 67 is provided. In addition, a feed roller pair 65 is provided to feed the sheet 67.

As described above, ink mist is adhered to a side surface 63 of the recording head 62 and becomes contaminants 66.

As shown in FIG. 5B, when recording proceeds, ink mist is further adhered, so that there is a concern of the contaminants 66 gradually growing in size and reaching the nozzle formation surface. In the related case, there is a concern of the contaminants coming into contact with the sheet 67 and contaminating the sheet 67. In addition, there is a concern of the contaminants covering the nozzles of the nozzle formation surface and affecting recording quality.

### SUMMARY

An advantage of some aspects of the invention is that it provides a recording apparatus which considers contaminants adhered to the side surfaces of a recording head.

According to an aspect of the invention, there is provided a recording apparatus including: a feeding unit which feeds a recording medium in a feeding direction; a recording head which discharges ink onto the recording medium for recording; and a first cleaning unit which performs first cleaning on at least one of a side surface on an upstream side of the feeding direction in the recording head, a side surface on a downstream side thereof, and side surfaces on both sides of a width direction of the recording medium with respect to the feeding direction.

According to the aspect, ink which is adhered to at least one of the surfaces of the recording head and solidifies can be removed by the first cleaning unit. As a result, recording can be performed properly. That is, there is no concern of the ink adhered to at least one of the surfaces contaminating the recording medium.

In the recording apparatus according to the aspect of the invention, a timing measuring unit which measures a timing of the first cleaning to be performed on at least one of the surfaces may further be included, and when the timing of the first cleaning is measured by the timing measuring unit, the first cleaning may be performed by the first cleaning unit.

According to the aspect, in addition to the same operation effects, the first cleaning can be performed at a predetermined appropriate timing. As a result, there is no concern of ink fixed to the side surfaces of the recording head growing in amount to affect recording quality.

In the recording apparatus according to the aspect of the invention, the first cleaning unit may further include a contaminant removing tool which is rotated by power of the feeding unit, and the contaminant removing tool may come into contact with at least one of the surfaces of the recording head as the recording head is moved to a cleaning position where the contaminant removing tool is provided, and the first cleaning may be performed as the contaminant removing tool is rotated by driving of the feeding unit.

According to the aspect, in addition to the same operation effects, the first cleaning can be automatically performed using power of the feeding unit. That is, there is no need to provide a new motor or the like. In addition, since the contaminant removing tool is rotated, solidified ink contaminants can be reliably dropped. That is, sticking contaminants can be cleaned. Particularly, this is effective when ink solidifies.

In the recording apparatus according to the aspect of the invention, a rotation direction of the contaminant removing tool may be a direction in which contact portions of the contaminant removing tool which comes into contact with the side surfaces of the recording head are directed from the side surfaces to a surface of the recording head through which ink is discharged.

According to the aspect, in addition to the same operation effects, ink which solidifies on the side surfaces of the recording head can be dropped in the direction in which ink is discharged.

In addition, in a case where ink adhered to the side surfaces of the recording head does not solidify but has a high viscosity, the adhered ink can be moved to the surface of the recording head through which ink is discharged.

In the recording apparatus according to the aspect of the invention, a second cleaning unit which performs second cleaning on the surface of the recording head through which the ink is discharged may further be included, and after the first cleaning is performed by the first cleaning unit, the second cleaning may be performed by the second cleaning unit.

According to the aspect, in addition to the same operation effects, in the case where ink adhered to the side surfaces of the recording head does not solidify but has a high viscosity, by performing the first cleaning, the adhered ink can be moved to the surface of the recording head through which ink is discharged. Thereafter, ink contaminants moved to the surface through which ink is discharged can be removed by performing the second cleaning. For example, by configuring the second cleaning unit in a wiping type, the ink contaminants sticking to the side surfaces are wiped away after being moved to the surface through which ink is discharged, which is effective. As a result, the entire recording head can be cleaned.

In the recording apparatus according to the aspect of the invention, the ink may be an organic solvent-based ink.

According to the aspect, in addition to the same operation effects, particularly in the case of the organic solvent-based ink, the ink is more likely to solidify and grow in amount when mist occurs. This is particularly effective in the related case.

### BRIEF DESCRIPTION OF THE DRAWINGS

The invention will be described with reference to the accompanying drawings, wherein like numbers reference like elements.

FIG. 1 is a side view schematically showing the inside of a printer of an embodiment.

FIG. 2 is a plan view schematically showing the inside of the printer of the embodiment.

FIGS. 3A and 3B are diagrams showing a cleaning unit of the embodiment.

FIG. 4 is a diagram showing a cleaning order of the embodiment.

FIGS. 5A and 5B are side views showing a problem in the related art.

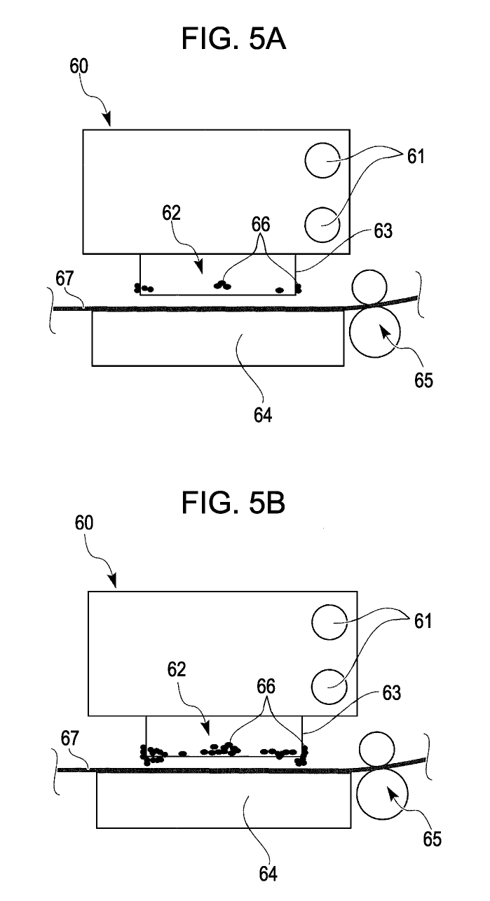

### DESCRIPTION OF EXEMPLARY EMBODIMENTS

Hereinafter, embodiments of the invention will be described with reference to the drawings.

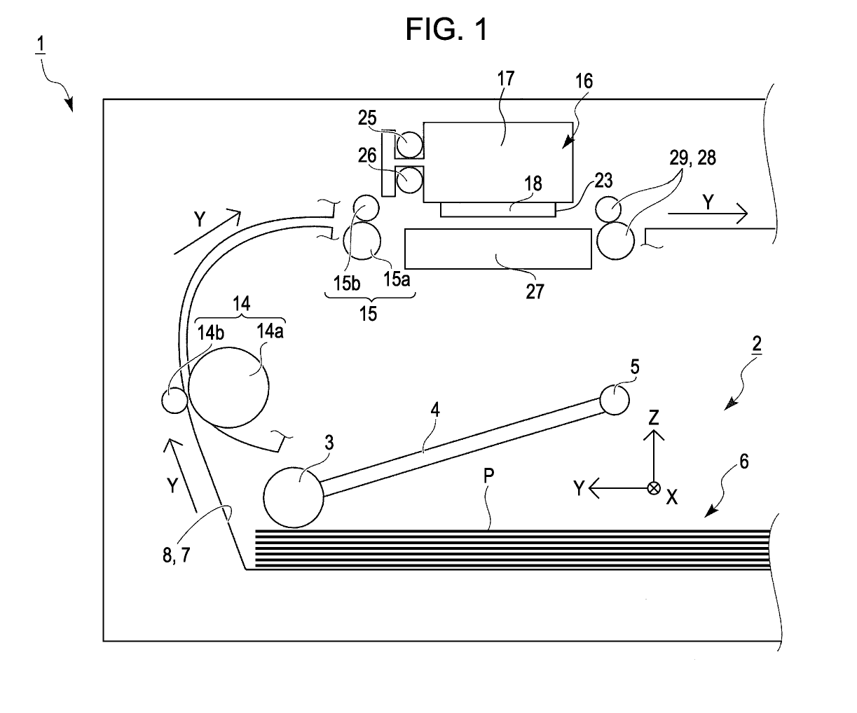

FIG. 1 is a side view schematically showing a printer which is an example of a recording apparatus related to an embodiment of the invention.

As shown in FIG. 1, a printer 1 related to the embodiment of the invention includes a medium feeding unit 2, a feeding path, a recording unit 16, and a discharge unit 28.

Particularly, the medium feeding unit 2 is provided to feed a sheet P which is an example of feeding medium in a feeding direction Y. The feeding path represents a path which is configured by a medium guide portion that guides the sheet P fed by the medium feeding unit or the like and on which the sheet P is fed.

The recording unit 16 is configured to perform recording on the sheet P fed by the medium feeding unit 2. In addition, the discharge unit 28 is provided to discharge the recorded sheet P so as to be placed on a discharge tray (not shown).

Specifically, the medium feeding unit 2 includes a placing portion 6, a pickup roller 3, an arm portion 4, a separation unit 7, a first roller pair 14, and a second roller pair 15. Particularly, the placing portion 6 is provided so that the sheets P are placed thereon. The pickup roller 3 can be driven by power of a motor and is provided to come into contact with the sheet P at the uppermost position in a stacking direction from among the sheets P stacked on the placing portion 6. A direction represented by the arrow of the Z axis is an upward direction of the stacking direction.

The arm portion 4 is provided to pivot from a pivot shaft 5 on the one side which is the upstream side of the feeding direction. In addition, the arm portion 4 is configured to hold the pickup roller 3 on the other side which is the downstream side of the feeding direction, so as to turn.

The motor may be provided at a point on a base body portion side of the printer 1 other than the arm portion 4 or may also be provided on the arm portion. In the former case, power is transmitted to the pickup roller 3 via the pivot shaft 5 by a power transmission unit such as a gear train. On the other hand, in the latter case, power is transmitted to the pickup roller 3 by the power transmission unit such as a gear train without the pivot shaft 5 therebetween.

The separation unit 7 is provided on the downstream side of the feeding direction from a point where the sheets P are set in the placing portion 6. Specifically, the separation unit 7 has an inclined surface 8 which is inclined with respect to a posture of the sheets P viewed from the side, which are fed by the pickup roller 3. In addition, when multiple feeding of the sheets P occurs, the separation unit 7 is provided to separate the sheet P at the uppermost position from the next and following sheets P with respect to the pickup roller 3. The separation unit 7 is a so-called bank separation mechanism.

Here, the “bank separation mechanism” represents a mechanism which provides a surface so as to cause the sheets P to enter at a predetermined angle and applies a load to the front ends of the sheets P to be separated.

In addition, the first roller pair 14 and the second roller pair 15 are provided to feed the sheets P passing through the separation unit 7 to the recording unit 16. Particularly, the first roller pair 14 has a first driving roller 14a and a first driven roller 14b.

Instead of the first driven roller 14b, a so-called retard roller which is accompanied with a predetermined load for turning may also be used. In the related case, when separation by the bank separation mechanism is made insufficiently, the sheets P which are subjected to the multiple feeding can be reliably separated. That is, the sheet which comes into direct contact with the first driving roller 14a can be separated further away from the sheet on the retard roller side than the sheet.

The second roller pair 15 is provided more on the downstream side than the first roller pair 14 in the feeding path. Specifically, the second roller pair 15 has a second driving roller 15a and a second driven roller 15b. For example, the second roller pair 15 is provided to feed the sheet P to the recording unit 16 with good precision using a stepping motor.

It is needless to say that when the front end of the sheet P reaches the second roller pair 15, correcting the posture of the sheet P with respect to the feeding direction Y, so-called skew correction is performed.

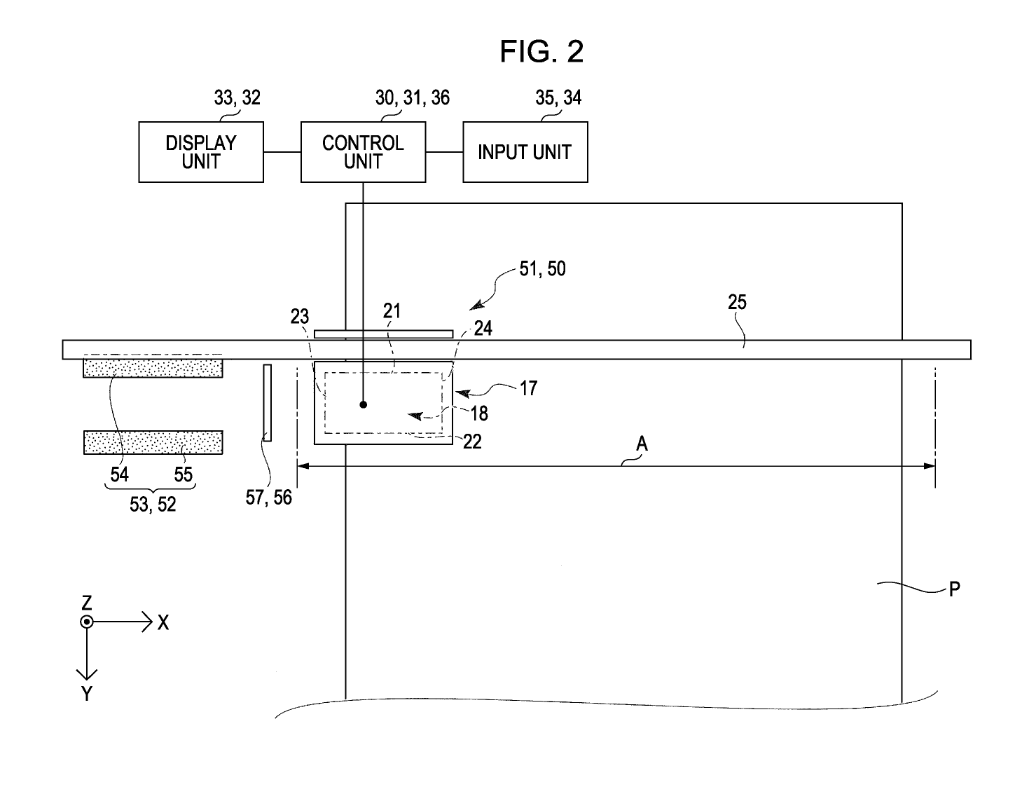

The recording unit 16 includes a carriage 17, a recording head 18, a medium support portion 27, a first guide shaft 25, and a second guide shaft 26. Particularly, the carriage 17 is configured to move in the width direction X while being guided by the first guide shaft 25 and the second guide shaft 26 extending in the width direction X of the sheet P. Although detailed description is omitted, power is transmitted to the carriage 17 by a well-known carriage moving unit 51 (see FIG. 2) described later to move the carriage 17 in the width direction X. The recording head 18 is provided in the carriage 17 and is provided to discharge ink onto the sheet P. Recording in a so-called ink jet type is performed. Reference numeral 23 denotes a left side surface of the recording head 18.

In addition, the medium support portion 27 is provided at a position opposing the recording head 18 to support the sheet P and is configured to maintain a distance between the sheet P and the recording head 18 as a predetermined interval.

The discharge unit 28 includes a third roller pair 29 and a discharge tray (not shown). The third roller pair 29 is provided more on the downstream side than the recording unit 16 in the feeding path and is provided to feed the recorded sheet P to the discharge tray.

The placing portion 6 of the medium feeding unit 2 may have a configuration of a so-called cassette type to be detachable from the printer main body or have a configuration formed integrally with the printer main body.

FIG. 2 is a plan view schematically showing the inside of the printer of the embodiment.

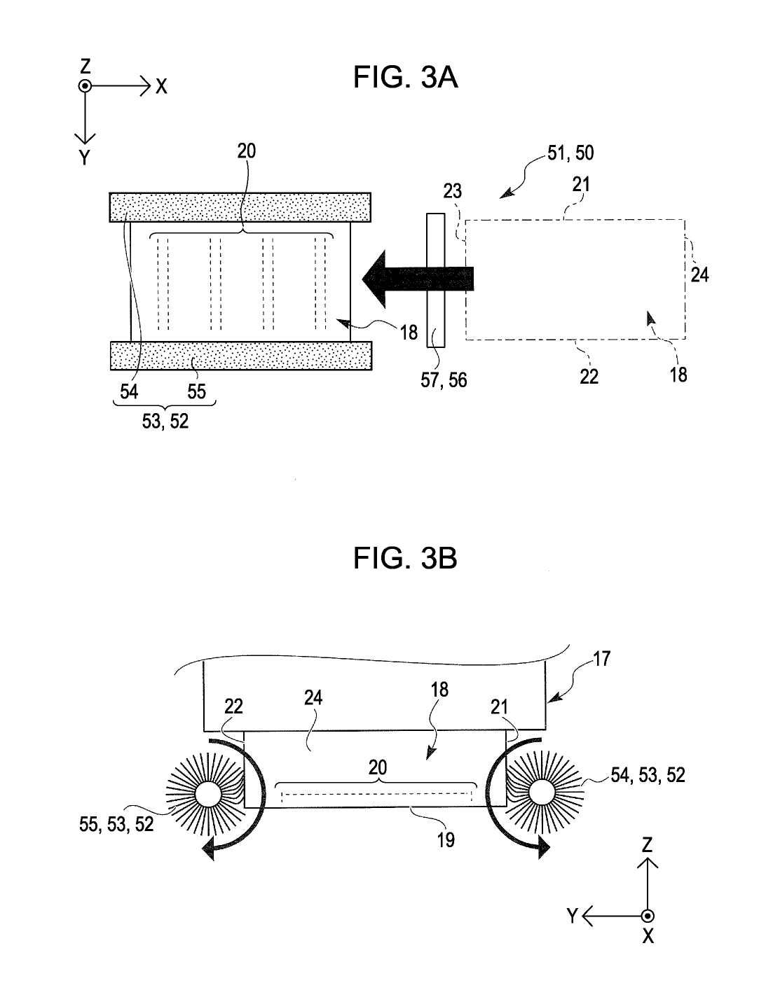

As shown in FIG. 2, the printer 1 of the embodiment further includes a first cleaning unit 52 and a second cleaning unit 56. Particularly, the first cleaning unit 52 is configured to perform first cleaning for cleaning side surfaces 21 to 24 of the recording head 18. On the other hand, the second cleaning unit 56 is configured to perform second cleaning for cleaning a nozzle formation surface 19 (see FIG. 3B) of the recording head 18.

The carriage 17 is provided to be moved in the width direction X by a carriage moving unit 51. For example, power of a dedicated motor is transmitted to the carriage 17 by an endless belt to move the carriage 17.

The first and second cleaning units 52 and 56 are disposed at, as an example of a predetermined position, the outside of a recording area A in a movement range of the carriage 17 in the width direction X. This is to cause the inside of the recording area not to be contaminated. However, of course, the first and second cleaning units 52 and 56 may also be disposed inside the recording area. Here, the recording area A is configured to be slightly wider than an area (range) in which the sheet P is fed in the width direction X. This is because recording is also performed on both ends of the width direction of the sheet P. This is so-called marginless recording.

Specifically, the first cleaning unit 52 has, as an example of a contaminant removing tool 53, a first rotation brush 54 and a second rotation brush 55. The first and second rotation brushes 54 and 55 are configured to be rotated by, for example, a power transmission unit (not shown) which transmits driving force of the second driving roller 15a (see FIG. 1) to the first and second rotation brushes 54 and 55. The power transmission unit may have a configuration which transmits power with an endless belt or a configuration which transmits power with a gear train. In addition, of course, a dedicated motor which drives the first and second rotation brushes 54 and 55 to rotate may also be provided.

The first cleaning unit 52 is particularly effective in a case of a configuration in which another member is present in the vicinity of the side surfaces 21 to 24 of the recording head 18 and thus a user's hand does not reach the side surfaces 21 to 24. Typically, in order to increase recording precision, an interval between the upstream side surface 21 of the recording head 18 and the second roller pair 15 is narrow. The first cleaning unit 52 is particularly effective in a case of such a configuration.

In addition, specifically, the second cleaning unit 56 has a wiper member 57 formed of rubber as an example. The wiper member 57 is configured to be moved in the Z axis direction by another power such as a cam. At a position at which the wiper member 57 is raised, the wiper member 57 is configured to come into contact with the nozzle formation surface 19 of the recording head 18 and wipe away contaminants thereon when the carriage 17 passes. On the other hand, at a position at which the wiper member 57 is lowered, the wiper member 57 is configured so as not to come into contact with the nozzle formation surface 19 of the recording head 18 when the carriage 17 passes. Therefore, depending on whether or not second cleaning is needed, the position of the wiper member 57 may be switched.

The second cleaning unit 56 is disposed between the first cleaning unit 52 and the recording area A. This is to efficiently perform cleaning as described later.

The printer 1 further includes a control unit 30, an informing unit 32, and a selection unit 34. Particularly, the control unit 30 is configured to measure, that is, estimate a timing of the first cleaning of the side surfaces 21 to 24 of the recording head 18. In addition, the informing unit 32 is provided to inform the user of the timing of the first cleaning. The selection unit 34 is provided for the user to select whether or not to perform the first cleaning.

Specifically, the control unit 30 has a timing measuring unit 31 and a number of times measuring unit 36. The timing measuring unit 31 is provided to, with respect to the previous first cleaning of the side surfaces 21 to 24 of the recording head 18, on the basis of a time that elapses thereafter or a count of the amount of ink discharged thereafter, measure a preferable timing of the next first cleaning. For example, in a case where a predetermined time elapses thereafter or in a case where the amount of ink discharged reaches a predetermined amount, a preferable timing of the next first cleaning may be determined. A configuration in which the timing is determined on the basis of a plurality of conditions provided in advance may also be employed.

The amount of ink mist adhered to the side surfaces of the recording head 18 may be roughly measured from the amount of ink discharged, and on the basis of this, the timing can be measured. By counting ink droplets discharged from the nozzles, the amount of ink discharged can be perceived.

The number of times measuring unit 36 is configured to measure the number of times at which the user continuously selects the first cleaning not to be performed using the selection unit 34.

Specifically, the informing unit 32 has a display unit 33 as an example. Of course, the informing unit 32 may also inform the user using a voice or a warning sound. In this embodiment, the intent that it is a preferable timing to perform the first cleaning is displayed to urge the user to perform the first cleaning.

Specifically, the selection unit 34 has an input unit 35 as an example. A selection may be input by a push-button or a touch panel, or may also be input to the printer 1 by operating a computer connected to the printer 1.

In addition, when the timing measuring unit 31 determines that it is a preferable timing, the intent that it is preferable timing to perform the first cleaning is displayed on the display unit 33. When the user selects the first cleaning, as described later, the carriage 17 is moved by the carriage moving unit 51 to a predetermined position where the first cleaning unit 52 is provided. Then, the first cleaning is performed.

Of course, a configuration in which a selection by the user using the selection unit 34 is not performed as long as the side surfaces 21 to 24 of the recording head 18 are cleaned by performing the first cleaning may also be employed. In other words, a configuration in which when it is a preferable timing, without performing selection, the first cleaning is performed may also be employed.

Subsequently, the first cleaning unit 52 will be described in more detail.

FIGS. 3A and 3B are diagrams showing the cleaning unit of this embodiment. Particularly, FIG. 3A is a schematic plan view showing a positional relationship between the recording head and the first cleaning unit. FIG. 3B is a schematic side view showing a positional relationship between the recording head and the first cleaning unit.

As shown in FIGS. 3A and 3B, when the carriage 17 is moved to the position where the first cleaning unit 52 is provided, the first rotation brush 54 comes into contact with the upstream side surface 21 of the recording head 18. Similarly, the second rotation brush 55 comes into contact with the downstream side surface 22 of the recording head 18. Here, as shown in FIG. 3B, it is preferable that contact points are close to the nozzle formation surface 19 in the side surfaces 21 and 22. In other words, it is preferable that the contact points be in the vicinity of the corner formed by the side surfaces 21 and 22 and the nozzle formation surface 19. The reason is that when ink mist is adhered to the side surfaces and contaminants grow in amount, the contaminants can be prevented from growing in size toward the nozzle formation surface 19. Accordingly, discharge defects due to ink masses covering a nozzle row 20 and contaminating the sheets due to ink masses coming into contact with the sheet P can be prevented.

As shown in FIG. 3B, after the movement of the carriage 17 is stopped, the first and second rotation brushes 54 and 55 are rotated to remove contaminants adhered to the side surfaces 21 and 22 of the recording head 18. Here, the rotation direction of the first and second rotation brushes 54 and 55 is a direction in which contaminants of the side surfaces 21 and 22 are moved downward as shown in FIG. 3B. Accordingly, when the adhered contaminants solidify, they may be dropped downward. Then, the contaminants may be put into a groove provided therebelow. If the brushes 54 and 55 are rotated in the reverse direction, there is a concern of the contaminants scattering upward.

In addition, in a case where the adhered contaminants do not completely solidify and have a viscosity, the contaminants may be moved downward to the end of the nozzle formation surface 19.

Thereafter, the carriage 17 is moved and the contaminants moved to the end of the nozzle formation surface 19 are scraped by the wiper member 57 of the second cleaning unit 56 to be cleaned. That is, the contaminants moved by the first cleaning can be removed using the second cleaning performed when recording is re-started.

When an object is only to simply remove the contaminants, of course, the rotation direction of the first and second rotation brushes 54 and 55 may be any direction.

Of course, a wiper member may be used as the first cleaning unit 52. The brushes are used in this embodiment because it is thought that a frequency of the first cleaning performed is lower than a frequency of the second cleaning performed and the contaminants adhered to the side surfaces 21 and 22 of the recording head 18 solidify. The brushes can scrape off the solidifying contaminants and thus are very effective.

As an example, the configuration in which the first and second rotation brushes 54 and 55 respectively clean the upstream side surface 21 and the downstream side surface 22 of the recording head 18 is employed; however, the embodiment is not limited thereto. A configuration in which four rotation brushes are disposed to clean the upstream side surface 21, the downstream side surface 22, the right side surface 23, and the left side surface 24 of the recording head 18 may also be employed. When the rotation brushes are provided to come into contact with the right side surface 23 and the left side surface 24, power of the second driving roller 15a may be transmitted by changing the direction of a rotation shaft using a bevel gear or a so-called universal joint of course.

In addition, a configuration in which a side surface that a user's hand can easily reach is cleaned by the user himself or herself with a cotton swab or the like may also be employed. In other words, a configuration in which cleaning is performed by the first rotation brush 54 of the first cleaning unit 52 only on the upstream side surface 21 that is difficult to reach by a user's hand may also be employed.

Subsequently, the entire cleaning order of this embodiment will be described in detail.

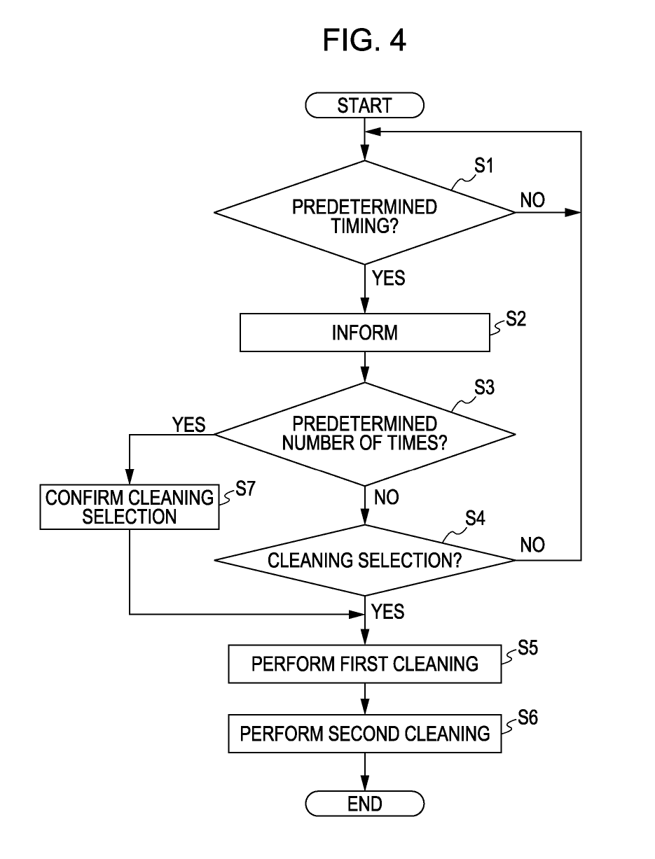

FIG. 4 is a diagram showing the entire cleaning order of this embodiment.

As shown in FIG. 4, in Step S1, it is determined whether or not it is a preferable predetermined timing to perform the first cleaning. Specifically, with respect to the previous first cleaning, on the basis of a time that elapses thereafter or the amount of ink discharged, the timing measuring unit 31 of the control unit 30 estimates the timing and determines whether or not the present time is the corresponding timing. When the corresponding timing is determined, the process proceeds to Step S2. When it is determined that the present time is not the timing yet, the process returns to Step S1 and is repeated.

In Step S2, the user is informed that it is the preferable predetermined timing to perform the first cleaning by the informing unit 32. For example, the intent may be displayed on the display unit 33 to be informed. Of course, the intent may also be informed by voice or warning sound. Then, the process proceeds to Step S3.

In Step S3, it is determined whether or not the number of times at which not performing the first cleaning is continuously selected until the previous time reaches a predetermined number of times. Specifically, whether or not a number of times measured by the number of times measuring unit 36 of the control unit 30 reaches the predetermined number of times is determined by the control unit 30. Here, the predetermined number of times may be a number of times which is allowed since recording quality is not significantly affected even though the first cleaning is not performed.

When it is determined that the number of times continuously selected does not reach the predetermined number of times, there is a selection margin of whether or not to perform the first cleaning, so that the process proceeds to Step S4. On the other hand, when it is determined that the number of times continuously selected reaches the predetermined number of times, there is no selection margin of whether or not to perform the first cleaning, so that the process proceeds to Step S7.

In Step S4, the user selects whether or not to perform the first cleaning using the selection unit 34. For example, whether or not to perform the first cleaning is input by the input unit 35 (see FIG. 2). When performing the first cleaning is selected, the process proceeds to Step S5. When not performing the first cleaning is selected, the reference by the timing measuring unit 31 is reset and then the process returns to Step S1. In the related case, since proceeding of recording has priority over performing the first cleaning, the recording may proceed.

As described above, of course, the configuration in which a selection by the user using the selection unit 34 is not performed as long as the side surfaces 21 to 24 of the recording head 18 are cleaned by performing the first cleaning may also be employed.

In Step S5, the first cleaning unit 52 performs first cleaning. Specifically, as described above, the carriage 17 is moved to the position where the first cleaning unit 52 is provided, and the first cleaning unit 52 cleans the side surfaces 21 to 24 of the recording head 18. Accordingly, contaminants as the ink mist is adhered to the side surfaces 21 to 24 are removed. Then the process proceeds to Step S6.

In Step S6, the second cleaning unit 56 performs the second cleaning. Specifically, as described above, in a state where the wiper member 57 of the second cleaning unit 56 is raised, the recording head 18 passes through on the wiper member 57. Accordingly, the contaminants of the nozzle formation surface 19 of the recording head 18 can be removed to be cleaned. Here, contaminants moved to the nozzle formation surface 19 from the side surfaces 21 to 24 by performing the first cleaning can also be removed. That is, cleaning can be performed with high efficiency. Then, the sequence is ended.

In Step S7, the user selects performing the first cleaning using the selection unit 34. In other words, Step S7 is a state where not performing the first cleaning cannot be selected. Accordingly, performing the first cleaning is forcibly selected. When performing the first cleaning is selected, the process proceeds to Step S5. As a result, as described above, contaminant masses of the ink mist adhered to the side surfaces 21 to 24 of the recording head 18 may be prevented from growing in size to affect the recording quality.

In this example, the configuration in which the carriage 17 is moved in the width direction X of the sheet P is described; however, a configuration in which the carriage 17 is moved in the feeding direction Y of the sheet P may also be employed. This is because even in the related case, the phenomenon in which ink mist is adhered to the side surfaces 21 to 24 of the recording head 18 occurs. In addition, a configuration in which the carriage 17 is not moved during performing of recording may also be employed. For example, the configuration is a configuration of a line head printer which is long in the width direction X. This is because even in the related art, the phenomenon in which ink mist is adhered to the side surfaces 21 to 24 of the recording head 18 occurs.

When the ink is an organic solvent-based ink, particularly there is a tendency of contaminants being more likely to grow in size by ink mist on the side surfaces of the recording head 18. This is because the solvent is vaporized and colorants (pigments or dyes) are more likely to solidify. Therefore, in the related case, the embodiment of the invention is particularly effective.

The organic solvent-based ink represents ink containing organic solvents. As the organic solvent used in this embodiment, preferably, polar organic solvents such as alcohols (for example, methanol, ethanol, propanol, butanol, isopropanol, fluorinated alcohols, and the like), ketones (for example, acetone, methylethyl ketone, cyclohexanone, and the like), carboxylates (for example, methyl acetate, ethyl acetate, propyl acetate, butyl acetate, methyl propionate, ethyl propionate, and the like), and ethers (diethyl ethers, dipropyl ether, tetrahydrofuran, dioxane, and the like) may be used.

The printer 1 as the recording apparatus of this embodiment includes the medium feeding unit 2 which is the feeding unit that feeds the sheet P that is an example of a recording medium in the feeding direction Y, the recording head 18 which discharges ink onto the sheet P for recording, and the first cleaning unit 52 which performs the first cleaning on at least one of the upstream side surface 21 which is a side surface on the upstream side of the feeding direction in the recording head 18, the downstream side surface 22 which is a side surface on the downstream side, and the right and left side surfaces 23 and 24 which are side surfaces on both sides of the width direction of the sheet P with respect to the feeding direction Y.

In this embodiment, the timing measuring unit 31 which measures a timing of the first cleaning to be performed on at least one of the surfaces is further included, and when the timing of the first cleaning is measured by the timing measuring unit 31, the first cleaning is performed by the first cleaning unit 52.

In addition, in this embodiment, the first cleaning unit 52 includes the contaminant removing tool 53 which is rotated by the power of the second driving roller 15a of the medium feeding unit 2, the contaminant removing tool 53 comes into contact with at least one of the surfaces 21 to 24 of the recording head 18 as the recording head 18 is moved to a predetermined position which is a cleaning position where the contaminant removing tool 53 is provided, and the first cleaning is performed as the contaminant removing tool 53 is rotated by driving of the second driving roller 15a.

In this embodiment, the first and second rotation brushes 54 and 55 are provided as an example of the contaminant removing tool 53; however, the embodiment is not limited thereto. In addition, the configuration in which the contaminant removing tool 53 is rotated by the power of the second driving roller 15a as an example is employed; however, the embodiment is not limited thereto. Power of the medium feeding unit 2 may be used. In addition, the first rotation brush 54 may be provided on the shaft of the second driving roller 15a. In the related case, the power transmission unit may be omitted.

In addition, in this embodiment, the rotation direction of the contaminant removing tool 53 is a direction in which the contact portions of the contaminant removing tool 53 which comes into contact with the side surfaces 21 to 24 of the recording head 18 are directed from the side surfaces 21 to 24 to the nozzle formation surface 19 in the recording head 18 which is a surface through which ink is discharged.

In addition, in this embodiment, the second cleaning unit 56 which performs the second cleaning on the nozzle formation surface 19 of the recording head 18 is further included, and after performing the first cleaning by the first cleaning unit 52, the second cleaning is performed by the second cleaning unit 56.

In this embodiment, ink is an organic solvent-based ink.

The invention is not limited to the embodiments and it is needless to say that various modifications can be made within the scope of the invention described in the above-described aspects and they are included in the scope of the invention.

What is claimed is:

1. A recording apparatus comprising:
a feeding unit which feeds a recording medium in a feeding direction;
a recording head which discharges ink onto the recording medium for recording; and
a first cleaning unit which performs first cleaning on at least one of a side surface on an upstream side of the feeding direction in the recording head, a side surface on a downstream side thereof, and side surfaces on both sides of a width direction of the recording medium with respect to the feeding direction.

2. The recording apparatus according to claim 1, further comprising a timing measuring unit which measures a timing of the first cleaning to be performed on at least one of the surfaces,
wherein, when the timing of the first cleaning is measured by the timing measuring unit, the first cleaning is performed by the first cleaning unit.

3. The recording apparatus according to claim 1,
wherein the first cleaning unit includes a contaminant removing tool which is rotated by the power of the feeding unit, and
the contaminant removing tool comes into contact with at least one of the surfaces of the recording head as the recording head is moved to a cleaning position where the contaminant removing tool is provided, and the first cleaning is performed as the contaminant removing tool is rotated by driving of the feeding unit.

4. The recording apparatus according to claim 3, wherein a rotation direction of the contaminant removing tool is a direction in which contact portions of the contaminant removing tool which comes into contact with the side surfaces of the recording head are directed from the side surfaces to a surface of the recording head through which ink is discharged.

5. The recording apparatus according to claim 4, further comprising a second cleaning unit which performs second cleaning on the surface of the recording head through which the ink is discharged,
wherein, after the first cleaning is performed by the first cleaning unit, the second cleaning is performed by the second cleaning unit.

6. The recording apparatus according to claim 1,
wherein the ink is an organic solvent-based ink.
